(19) United States
(12) Patent Application Publication
(10) Pub. No.: US 2025/0092908 A1
(43) Pub. Date: Mar. 20, 2025

(54) SINGLE-LAYERED HOLLOW TRANSMISSION SHAFT

(71) Applicant: NATIONAL CHENG KUNG UNIVERSITY, Tainan City (TW)

(72) Inventor: Chao-Chieh LAN, Tainan City (TW)

(73) Assignee: NATIONAL CHENG KUNG UNIVERSITY, Tainan City (TW)

(21) Appl. No.: 18/368,121

(22) Filed: Sep. 14, 2023

(51) Int. Cl. F16C 3/02

(52) U.S. Cl. CPC F16C 3/02

(57) ABSTRACT

A single-layered hollow transmission shaft comprises a hollow shaft body. The hollow shaft body has a power-inputting end and a power-outputting end, which are formed at two opposite ends of the hollow shaft body, and at least one multi-start helix set. The multi-start helix set has a left-coiling multi-start helix section and a right-coiling multi-start helix section, which are arranged axially and have an equal pitch, number of circles, number of starts of helix and width of helix. By a single-layered structure and a structural design of the multi-start helix set, the single-layered hollow transmission shaft provides sufficient space for wiring of communication and can transmit power with pure torque while the shaft rotates, therefore increasing precision of torque detection, and can detect torque while rotating at high speed without installing any other external element and without affecting size of the space inside the shaft.

### BACKGROUND OF THE INVENTION

### 1. Field of the Invention

The present invention relates to a single-layered hollow transmission shaft, especially to a single-layered hollow transmission shaft that can be applied to a joint module of a robot and provides a power transmission function.

### 2. Description of Related Art

In normal joints modules of a robot, a transmission shaft is used to transmit power. Transmitting torque from a power-inputting end of the transmission shaft to a power-outputting end of the transmission shaft, the transmission shaft rotates at a high speed.

A conventional transmission shaft mainly is a machined spring with a multi-layered structure. Although it provides a function of outputting wide-range torsional angle proportional to a torque, the transmission shaft with multi-layered structure has a difficulty of arranging communication wiring when practically applicated.

To avoid affecting power transmission while effectively utilizing a space in the transmission shaft, the transmission shaft nowadays possesses a hollow passage with a large bore, so the transmission shaft can be a thin-wall structure to provide space for communication wiring of robots.

Besides, to measure a torque of the transmission shaft, measuring components, such as strain gauges, need to be installed at an outer side of the transmission shaft. However, after installing the measuring components, wirings on the transmission shaft will be more complicated. Such complexity is unfavorable for high-speed rotation and has a drawback of difficulty in measuring a wide-range torsional angle.

Therefore, how to provide a transmission shaft, which has a hollow passage with a large bore and can tolerate wide-range torsional angle proportional to a torque without installing external components and without affecting transmitting effect, is the objective of the present invention.

### SUMMARY OF THE INVENTION

The mean objective of the present invention is to provide a single-layered hollow transmission shaft, which can tolerate wide-range torsional angle proportional to a torque while precisely measuring the torque at the same time without installing external components and without affecting transmitting effect, and has a hollow passage with a large bore.

The single-layered hollow transmission shaft comprises a hollow shaft body, a power-inputting end and a power-outputting end. The power-inputting end and the power-outputting end are respectively formed at two axially-opposite ends of the hollow shaft body. The hollow shaft body has at least one multi-start helix set. The at least one multi-start helix set comprises a left-coiling multi-start helix section and a right-coiling multi-start helix section, which are arranged axially. The left-coiling multi-start helix section and the right-coiling multi-start helix section have an equal pitch, number of circles, number of starts of helix and width of helix, such that a torsional power inputted from the power-inputting end is transmitted to the power-outputting end by the at least one multi-start helix set of the hollow shaft body in pure-torque transmission.

The single-layered hollow transmission shaft can be applied to a joint module of a robot and is configured to provide a power transmission function. The single-layered hollow transmission shaft has the following characteristics:

1. Single-layered structure: The single-layered hollow transmission shaft is a hollow structure with a single layer. In manufacture, a whole structure of the single-layered hollow transmission shaft is simple and easy to be processed, therefore reducing a manufacturing cost and can be formed one-piece with other components. Besides, a single-layered structure expands an interior space, reduces its volume, and facilitates ease in arranging the communication wiring.

2. Pure-torque transmission: By a structural design of the at least one multi-start helix set of the hollow shaft body, while rotating, the single-layered hollow transmission shaft can eliminate reaction forces from other directions, therefore effectively decreasing loads on bearings mounted at two ends of the shaft and prolonging life of the bearings.

Besides, by pure-torque transmission, the single-layered hollow transmission shaft generates an amount of torsional angle proportional to a torque. Therefore, the amount of torsional angle can be measured by conventional encoders mounted at the power-inputting end and the power-outputting end to convert into the torque. So, the torque of the single-layered hollow transmission shaft can be measured during high-speed rotating without installing external components and without affecting a size of an interior space.

Furthermore, by pure-torque transmission, the single-layered hollow transmission shaft facilitates a deformation of a hollow shaft while rotating in large angle, therefore increasing precision of torque measurement and decreasing inaccuracy of angle measurement.

3. Less reaction force when deforming in large angle: By the structural design of the at least one multi-start helix set of the hollow transmission shaft, a reaction force on the single-layered hollow transmission shaft is decreased when deforming in large angle, so the single-layered hollow transmission shaft is not prone to damage by the impact of the reaction force.

### BRIEF DESCRIPTION OF THE DRAWINGS

FIG. 1 is a perspective view of a first embodiment of a single-layered hollow transmission shaft in accordance with the present invention;

FIG. 2 is a front view of the first embodiment of the single-layered hollow transmission shaft in accordance with the present invention;

FIG. 3 is a front view of a second embodiment of the single-layered hollow transmission shaft in accordance with the present invention;

FIG. 4 is a front view of a third embodiment of the single-layered hollow transmission shaft in accordance with the present invention;

FIG. 5 is a front view of a fourth embodiment of the single-layered hollow transmission shaft in accordance with the present invention;

FIG. 6 is a front view of a fifth embodiment of the single-layered hollow transmission shaft in accordance with the present invention;

FIG. 7 is a front view of a sixth embodiment of the single-layered hollow transmission shaft in accordance with the present invention;

FIG. 8 is a force-relationship simplified view of a hollow transmission shaft being twisted by a rotating angle θ; and

FIG. 9 is a simplified diagram of the single-layered hollow transmission shaft in accordance with the present invention, compared to each comparative example.

### DETAILED DESCRIPTION OF THE PREFERRED EMBODIMENT

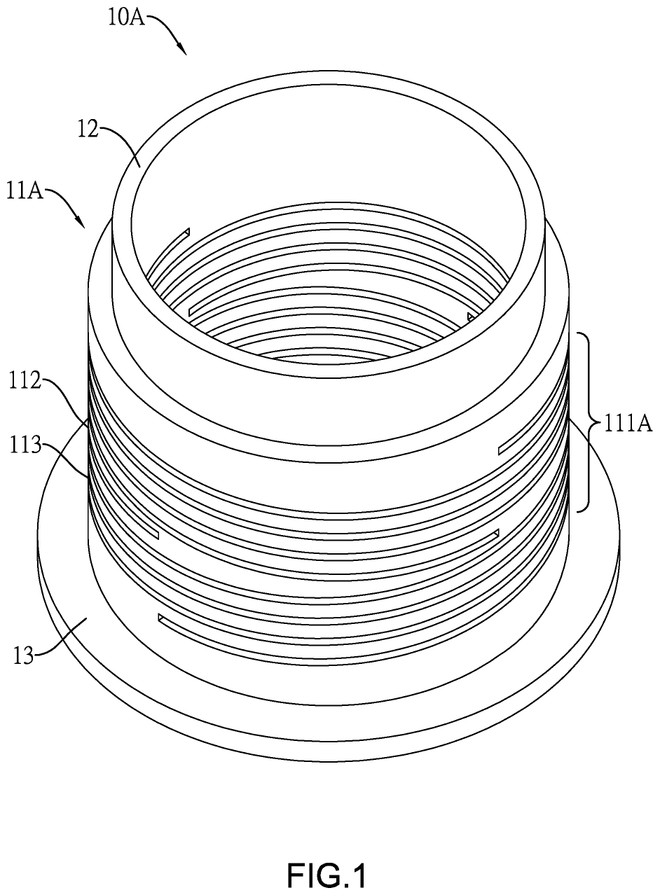

With reference to FIGS. 1 to 7, multiple embodiments of a single-layered hollow transmission shaft 10A to 10F in accordance with the present invention are shown. The single-layered hollow transmission shaft 10A to 10F comprises a hollow shaft body 11A to 11F, a power-inputting end 12 and a power-outputting end 13. The power-inputting end 12 and the power-outputting end 13 are respectively formed at two axially-opposite ends of the hollow shaft body 11A to 11F.

With reference to FIGS. 1 to 7, the hollow shaft body 11A to 11F has at least one multi-start helix set 111A to 111F. The at least one multi-start helix set 111A to 111F comprises a left-coiling multi-start helix section 112 and a right-coiling multi-start helix section 113 that are arranged axially. The left-coiling multi-start helix section 112 and the right-coiling multi-start helix section 113 have an equal pitch, number of circles, number of starts of helix and width of helix, such that a torsional power inputted from the power-inputting end 12 is transmitted to the power-outputting end 13 by the at least one multi-start helix set 111A to 111F of the hollow shaft body 11A to 11F in pure-torque transmission. The definition of pure-torque transmission of a shaft is that the shaft can transmit power through pure torsion without generating reaction forces in other directions, so that only torque will be transmitted. In addition, the left-coiling multi-start helix section 112 and the right-coiling multi-start helix section 113 of the at least one multi-start helix set 111A to 111F can be preset to have two, three or more starts according to needs. Drawings of each preferable embodiment of the single-layered hollow transmission shaft 10A to 10F take two starts as examples to explain the present invention.

With reference to FIGS. 1 to 7, a length of the hollow shaft body 11A to 11F, an amount of the at least one multi-start helix set 111A to 111F and arrangements of the at least one multi-start helix set 111A to 111F can be set according to needs. Additionally, the amount of the at least one multi-start helix set 111B, 111D to 111F of the hollow shaft body 11B, 11D to 11F is multiple and the multiple multi-start helix sets 111B, 111D to 111F are arranged axially. Besides, the hollow shaft body 11C to 11F comprises at least one linear tubular section 14, which is formed between the left-coiling multi-start helix section 112 and the right-coiling multi-start helix section 113 of the at least one multi-start helix set 111C, 111D, 111F. And in the embodiments, which have multiple multi-start helix sets 111E, 111F, of the present invention, the at least one linear tubular section 14 is formed between two adjacent multi-start helix sets 111E, 111F. Each embodiment of the present invention will be described as follows.

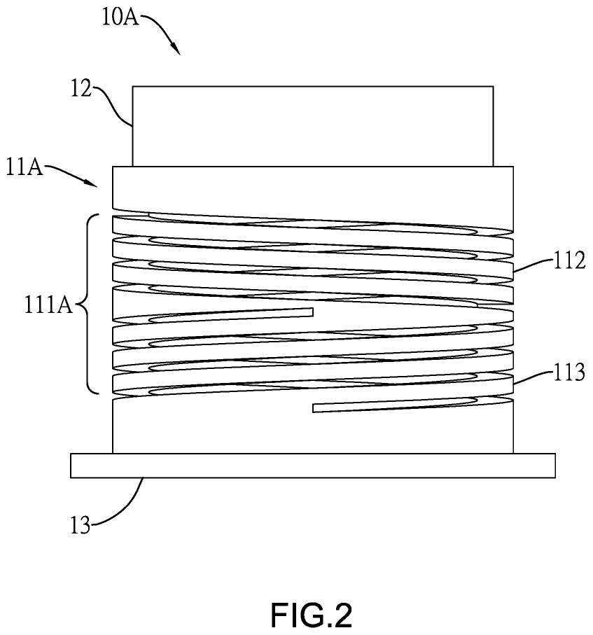

With reference to FIGS. 1 and 2, in a first embodiment of the single-layered hollow transmission shaft 10A, the single-layered hollow transmission shaft 10A has one said multi-start helix set 111A. The left-coiling multi-start helix section 112 and the right-coiling multi-start helix section 113 of the multi-start helix set 111A are arranged axially and are adjacent to each other.

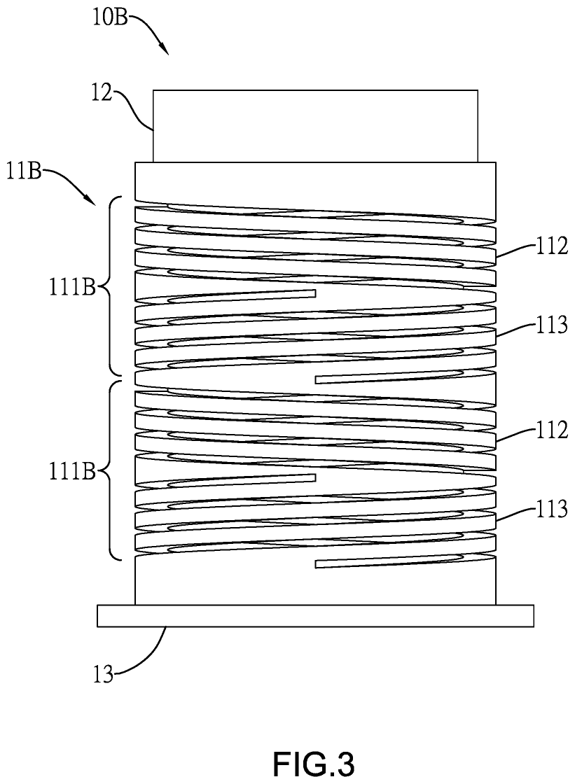

With reference to FIG. 3, in a second embodiment of the single-layered hollow transmission shaft 10B, the single-layered hollow transmission shaft 10B has two said multi-start helix sets 111B. The two multi-start helix sets 111B are arranged axially and are adjacent to each other.

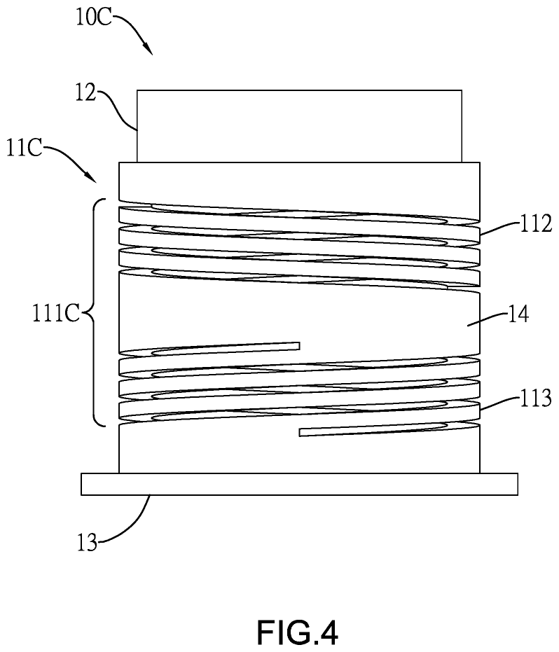

With reference to FIG. 4, in a third embodiment of the single-layered hollow transmission shaft 10C, the single-layered hollow transmission shaft 10C has one said multi-start helix set 111C. The hollow shaft body 11C comprises one said linear tubular section 14. The linear tubular section 14 is formed between the left-coiling multi-start helix section 112 and the right-coiling multi-start helix section 113 of the multi-start helix set 111C.

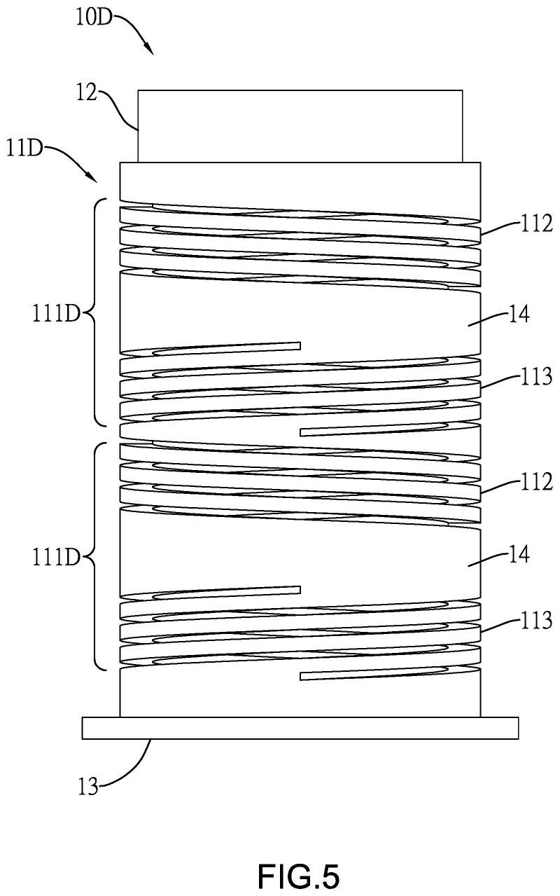

With reference to FIG. 5, in a fourth embodiment of the single-layered hollow transmission shaft 10D, the single-layered hollow transmission shaft 10D has two said multi-start helix sets 111D. The hollow shaft body 11D comprises two said linear tubular sections 14. Each of the two linear tubular sections 14 is formed between the left-coiling multi-start helix section 112 and the right-coiling multi-start helix section 113 of one of the two multi-start helix sets 111D.

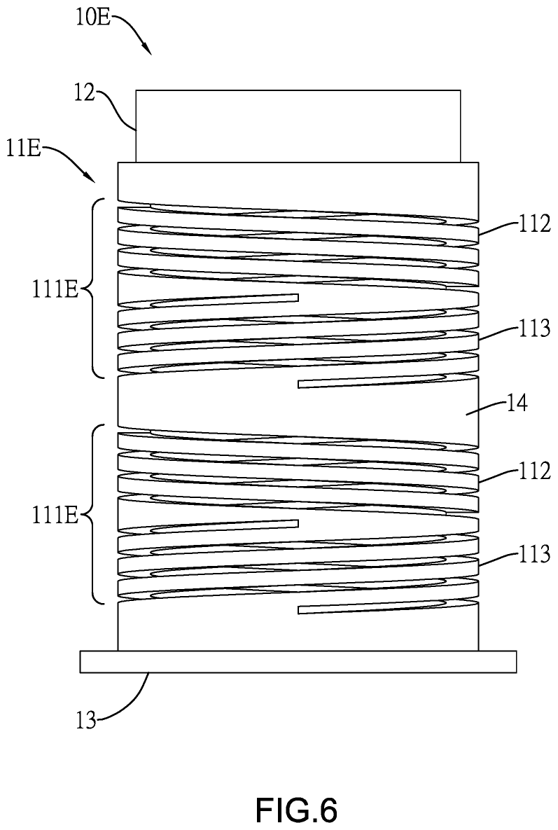

With reference to FIG. 6, in a fifth embodiment of the single-layered hollow transmission shaft 10E, the single-layered hollow transmission shaft 10E has two said multi-start helix sets 111E. The hollow shaft body 11E has one said linear tubular section 14, which is formed between the two adjacent multi-start helix sets 111E.

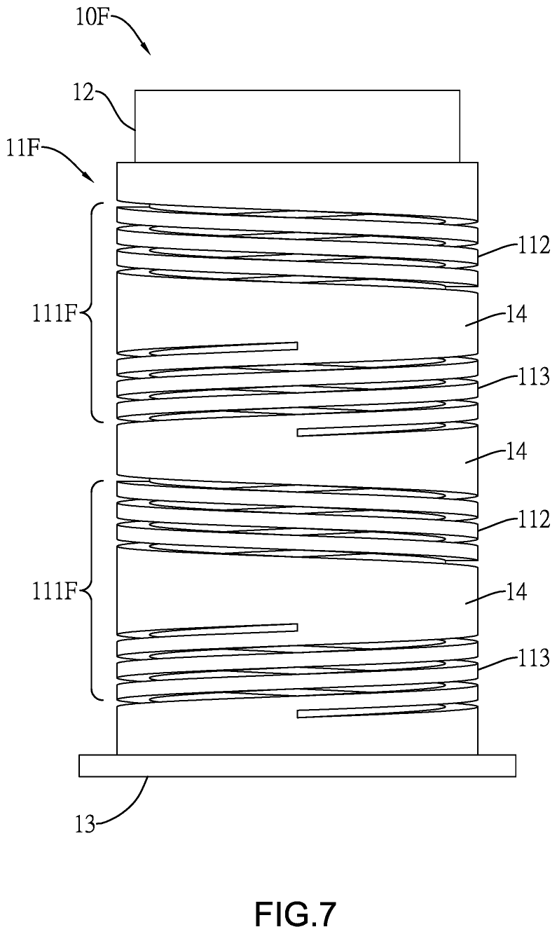

With reference to FIG. 7, in a sixth embodiment of the single-layered hollow transmission shaft 10F, the single-layered hollow transmission shaft 10F has two said multi-start helix sets 111F. The hollow shaft body 11F has three said linear tubular sections 14. Two of the three linear tubular sections 14 are formed respectively between the left-coiling multi-start helix section 112 and the right-coiling multi-start helix section 113 of the two multi-start helix sets 111F, and the rest one of the three linear tubular sections 14 is formed between the two adjacent multi-start helix sets 111F.

The single-layered hollow transmission shaft 10A to 10F can proceed with synchronous drive by installing motors or reduction gears at the power-inputting end 12 and the power-outputting end 13. An interior space of the hollow shaft body 11A to 11F of the pure-torque-transmission single-layered hollow transmission shaft 10A to 10F is provided for communication wiring. Additionally, the single-layered hollow transmission shaft 10A to 10F is a hollow structure with a single layer, so a whole structure of the single-layered hollow transmission shaft 10A to 10F is simple and easy to be processed, therefore reducing a manufacturing cost and can be formed one-piece with other components. Besides, a single-layered structure can expand an interior space and reduce a volume at the same time, therefore increasing ease of arranging communication wiring.

By a structural design of the at least one multi-start helix set 111A to 111F of the hollow shaft body 11A to 11F, while rotating, the single-layered hollow transmission shaft 10A to 10F will not generate reaction forces from other directions. Therefore, loads on bearings mounted at two ends of the shaft are effectively decreased, life of the bearings is prolonged, and inaccuracy of angle measurement are decreased.

Besides, because pure-torque transmissions will not generate reaction forces from other directions, an amount of torsional angle and a torque of the single-layered hollow transmission shaft 10A to 10F are proportional to each other. Therefore, the amount of torsional angle can be measured by conventional encoders mounted at the power-inputting end 12 and the power-outputting end 13 to convert into the torque. So, the torque of the single-layered hollow transmission shaft 10A to 10F can be measured during high-speed rotating without installing external components and without affecting a size of an interior space. Further, the single-layered hollow transmission shaft 10A to 10F can facilitate deformation of a hollow shaft while rotating in large angle, therefore increasing precision of torque measurement and decreasing inaccuracy of angle measurement.

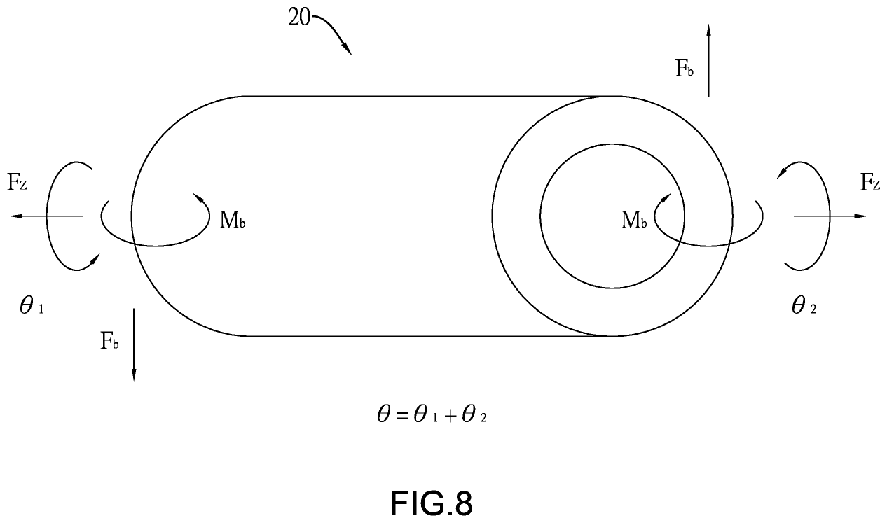

To precisely achieve pure-torque transmission, applicants of the present invention make the following analysis and comparisons. With reference to FIG. 8, while a hollow transmission shaft 20 is twisted by a rotating angle θ, two opposite ends of the hollow transmission shaft 20 respectively rotate by a θ1 angle and a θ2 angle. At the same time, the hollow transmission shaft 20 generates an axial force F_{z}, a radial force F_{b} and a radial torque M_{b}. After simulating analysis and differentiating the axial force F_{z}, the radial force F_{b} and the radial torque M_{b} by the rotating angle θ, the following changing rates are obtained:

$$\frac{{dF}_{Z}}{d θ} ,$$

which is a changing rate of the axial force F_{z} to the rotating angle θ;

$$\frac{{dF}_{b}}{d θ} ,$$

which is a changing rate of the radial force F_{b} to the rotating angle θ;

$$\frac{{dM}_{b}}{d θ} ,$$

which is a changing rate of the radial torque M_{b} to the rotating angle θ.

Besides, after simulating analysis, a changing rate is obtained as follows:

$$\frac{dS}{d θ} ,$$

which is a changing rate of a stress S to the rotating angle θ.

Among them, by the abovementioned four data of the changing rates, while the hollow transmission shaft 20 rotates, changing amounts of the axial force F_{z}, the radial force F_{b}, the radial torque M_{b} and the stress S to the rotating angle θ, increasing or decreasing, can be analyzed. For example, when the changing rate of the axial force F_{z} to the rotating angle θ is zero, it means that while the hollow transmission shaft 20 is rotating, the hollow transmission shaft 20 does not generate the axial force F_{z} with the increasing rotating angle θ. When the changing rate of the axial force F_{z} to the rotating angle θ is not zero, it means that while the hollow transmission shaft 20 is rotating, the hollow transmission shaft 20 generates the axial force F_{z}, and the axial force F_{z} changes with the increasing rotating angle θ. Additionally, an amount of the axial force F_{z} to the rotating angle θ reflects an increasing margin of the axial force F_{z} when the rotating angle θ increases.

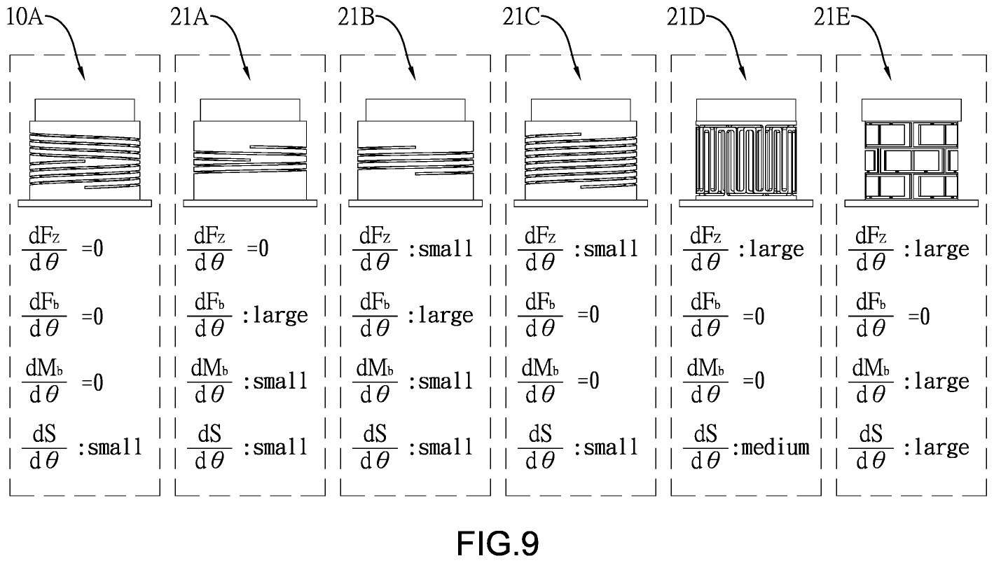

With reference to FIG. 9, to highlight characteristics of the single-layered hollow transmission shaft 10A in accordance with the present invention, the applicant provides several single-layered hollow transmission shafts in different structures as comparative examples 21A to 21E to compare with the first embodiment of the single-layered hollow transmission shaft 10A. Each of the comparative examples 21A to 21E of the hollow transmission shafts is described as follows.

A first comparative example 21A of the single-layered hollow transmission shaft has a shaft body, which has a left-coiling single-start helix section and a right-coiling single-start helix section, which are arranged axially. With reference to data related to the first comparative example 21A shown in FIG. 9, while the first comparative example 21A rotates, a small amount of the radial torque M_{b}, a small amount of the stress S and a large amount of the radial force F_{b} are generated, but the axial force F_{z} will not be generated.

A second comparative example 21B of the single-layered hollow transmission shaft has a shaft body, which forms a right-coiling single-start helix section. With reference to data related to the second comparative example 21B shown in FIG. 9, while the second comparative example 21B rotates, a small amount of the axial force F_{z}, a small amount of the radial torque M_{b}, a small amount of the stress S and a large amount of the radial force F_{b} are generated.

A third comparative example 21C of the single-layered hollow transmission shaft has a shaft body, which forms a right-coiling double-start helix section. With reference to data related to the third comparative example 21C shown in FIG. 9, while the third comparative example 21C rotates, a large amount of the axial force F_{z} and a small amount of the stress S are generated, but the radial force F_{b} and the radial torque M_{b} will not be generated.

A fourth comparative example 21D of the single-layered hollow transmission shaft has a shaft body, which forms a circuitous structure extending axially. With reference to data related to the fourth comparative example 21D shown in FIG. 9, while the fourth comparative example 21D rotates, a large amount of the axial force F_{z} and a medium amount of the stress S are generated, but the radial force F_{b} and the radial torque M_{b} will not be generated.

A fifth comparative example 21E of the single-layered hollow transmission shaft has a shaft body, which forms a gridded structure. With reference to data related to the fifth comparative example 21E shown in FIG. 9, while the fifth comparative example 21E rotates, a large amount of the axial force F_{z}, a large amount of the radial torque M_{b} and a large amount of the stress S are generated, but the radial force F_{b} will not be generated.

With reference to FIGS. 1 and 2, the hollow shaft body 11A of the single-layered hollow transmission shaft 10A forms the at least one multi-start helix set 111A that has the left-coiling multi-start helix section 112 and the right-coiling multi-start helix section 113. With reference to data related to the single-layered hollow transmission shaft 10A shown in FIG. 9, it is obvious that while the single-layered hollow transmission shaft 10A rotates, the axial force F_{z}, the radial force F_{b} and the radial torque M_{b} will not be generated and only a small amount of the stress S is generated. Therefore, the torsional power inputted from the power-inputting end 12 is transmitted to the power-outputting end 13 by the at least one multi-start helix set 111A of the hollow shaft body 11A in pure-torque transmission.

According to the abovementioned comparation, while rotating, the single-layered hollow transmission shaft 10A will not generate reaction forces from other directions and only generates small amount of the stress S when rotating by a large angle, and therefore can precisely achieve pure-torque transmission. Alternatively, although the first comparative example 21A, the second comparative example 21B and the third comparative example 21C all use helix structures and generate similar amounts of the stress S to the present invention while rotating, they all generate reaction forces from other directions. As for the fourth comparative example 21D and the fifth comparative example 21E, which use non-helix structures, they tend to generate a larger amount of the stress S while rotating and the axial force F_{z} when they are deformed by rotations is larger too, so they do not have an advantage of pure-torque transmission.

Besides, by the at least one multi-start helix set 111A to 111F of the hollow shaft body 11A to 11F, the single-layered hollow transmission shaft 10A to 10F provides sufficient axial rotational rigidity. Therefore, the single-layered hollow transmission shaft 10A to 10F can be applied to a joint module of a robot for power transmission, and it can also be used as a coupler for power transmission.

To sum up, by the single-layered structure and the structural design of the at least one multi-start helix set 111A to 111F of the hollow shaft body 11A to 11F, the single-layered hollow transmission shaft 10A to 10F provides sufficient space for wiring of communication. Simultaneously, the single-layered hollow transmission shaft 10A to 10F transmits power in pure-torque transmission while rotating, therefore effectively increasing precision of torque detection, and can detect torque while rotating at high speed without installing any other external element and without affecting sizes of the interior space.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A single-layered hollow transmission shaft comprising:
a hollow shaft body;
a power-inputting end; and
a power-outputting end; the power-inputting end and the power-outputting end respectively formed at two axially-opposite ends of the hollow shaft body; the hollow shaft body having
at least one multi-start helix set comprising
a left-coiling multi-start helix section; and
a right-coiling multi-start helix section; the left-coiling multi-start helix section and the right-coiling multi-start helix section arranged axially and having an equal pitch, number of circles, number of starts of helix and width of helix, such that a torsional power inputted from the power-inputting end is transmitted to the power-outputting end by the at least one multi-start helix set of the hollow shaft body in pure-torque transmission.

2. The single-layered hollow transmission shaft as claimed in claim 1, wherein an amount of the at least one multi-start helix set of the hollow shaft body is multiple and the multiple multi-start helix sets are arranged axially.

3. The single-layered hollow transmission shaft as claimed in claim 1, wherein the hollow shaft body comprises at least one linear tubular section formed between the left-coiling multi-start helix section and the right-coiling multi-start helix section of the at least one multi-start helix set.

4. The single-layered hollow transmission shaft as claimed in claim 2, wherein the hollow shaft body comprises at least one linear tubular section formed between the left-coiling multi-start helix section and the right-coiling multi-start helix section of the multiple multi-start helix sets.

5. The single-layered hollow transmission shaft as claimed in claim 2, wherein the hollow shaft body comprises at least one linear tubular section formed between the multiple multi-start helix sets.

6. The single-layered hollow transmission shaft as claimed in claim 2, wherein the hollow shaft body comprises multiple linear tubular sections; some of the multiple linear tubular sections formed between the left-coiling multi-start helix section and the right-coiling multi-start helix section of the multiple multi-start helix sets and the rest of the multiple linear tubular sections formed between the multiple multi-start helix sets.
